(19) United States
(12) Patent Application Publication
(10) Pub. No.: US 2010/0253547 A1
(43) Pub. Date: Oct. 7, 2010

(54) Geographically Selective Messaging System and Process

(76) Inventor: Robert John Tenetylo, Carrollton, VA (US)

Correspondence Address: LOUIS VENTRE, JR, 2483 OAKTON HILLS DRIVE, OAKTON, VA, 22124-1530, US

(21) Appl. No.: 12/418,636

(22) Filed: Apr. 6, 2009

(51) Int. Cl. G08B 23/00; G08B 5/22

(52) U.S. Cl. 340/984; 340/7.57

(57) ABSTRACT

A device and process for selectively communicating a digital audio message to a maritime vessel equipped with a Digital Selective Calling radio when the vessel is within a geographic area. The process involves steps of inputting geographical location information for a sensed maritime vessel to a computer processor; creating signal formatting instructions for a Geographical Area Call to the vessel that rings the vessel's radio, and then automatically tunes the radio to a clear frequency to receive a digital audio message; transmitting the signal to the vessel; and, transmitting the digital audio message to the vessel on the clear frequency. Optionally, the process includes a step of receiving input of frequency use data from a radio receiver/scanner to select a clear frequency to send the digital audio message. The device of the invention includes a computer readable medium storing instructions for implementing the process.

### TECHNICAL FIELD

In the field of communications by means which are in part electrically controlling, a device and method are disclosed for automated, selective radio communication and voice messaging, comprising a humanly perceptible indication on a Digital Selective Calling radio by transmission of a designated distinctive control signal.

### BACKGROUND ART

Digital Selective Calling is an integral part of the Global Maritime Distress Safety System. Geographic Area Calling is one of many types of Digital Selective Calling calls. Digital Selective Calling protocols for Geographic Area Calls are set forth in the International Telecommunications Union's ITU-R M.493.

Vessels with Digital Selective Calling-capable radios, if properly configured and interfaced with a Global Positioning System receiver, will process incoming Digital Selective Calling Geographic Area Calls when the vessel is within a prescribed geographical “box,” defined in latitude and longitude by the calling party's Digital Selective Calling controller/transmitter. If outside this defined geographical box, a receiving vessel's radio will not process the incoming Geographic Area Call and nothing will be heard by the operator.

The Federal Communications Commission requires that all marine radios manufactured after June, 2000 have at least minimal Digital Selective Calling capabilities, but these minimal capabilities do not require a system properly configured and interfaced with a Global Positioning System receiver such that Digital Selective Calling communications can be automated.

### SUMMARY OF INVENTION

A device and process for selectively communicating a digital audio message to a maritime vessel equipped with a Digital Selective Calling radio when the vessel is within a geographic area. The process involves steps of inputting geographical location information for a sensed maritime vessel to a computer processor; creating signal formatting instructions for a Geographical Area Call to the vessel that rings the vessel's radio, and then automatically tunes the radio to a clear frequency to receive a digital audio message; transmitting the signal to the vessel; and, transmitting the digital audio message to the vessel on the clear frequency. Optionally, the process includes a step of receiving input of frequency use data from a radio receiver/scanner to select a clear frequency to send the digital audio message. The device of the invention includes computer readable medium storing instructions for implementing the process.

Technical Problem

Numerous maritime port security systems exist that detect and track the location of vessels. For example, these security systems comprise radar, cameras, and other equipment. Location data is typically communicated in National Marine Electronics Association format.

The problem with these systems is the inability to automatically and selectively establish radio communications with most sensor-detected vessels.

A radio broadcast on a distress frequency is generally the only means to establish communications with smaller vessels. This approach is problematic because the message is not directed to a specific vessel. Furthermore, these distress frequencies are already overcrowded, and should be reserved for actual distress communications, not routine communications and other communications intended for vessels transmitting a limited geographic area.

Solution to Problem

Enable an automatic audio message to be sent to a vessel within a geographic area when the vessel is equipped with minimal Digital Selective Calling Geographical Area Call radio functionality by combining vessel location sensor information with a processor and transceiver capable of creating signal formatting instructions for a Geographical Area Call using the location sensor information and automatically activating transmission of a signal to the vessel ending with receipt of the message at the vessel.

### ADVANTAGEOUS EFFECTS OF INVENTION

The invention provides for automated, selective radio communication and voice messaging to a vessel transmitting a geographic area. While the invention may be the only automated means for contacting a small vessel equipped with a Digital Selective Calling system properly configured and interfaced with a Global Positioning System receiver, it also provides a redundant means for automatically contacting large vessels equipped with both an Automatic Identification System transponder and a Digital Selective Calling system properly configured and interfaced with a Global Positioning System receiver.

### BRIEF DESCRIPTION OF DRAWINGS

FIG. 1 is a flow diagram of a preferred embodiment of the process of the invention.

FIG. 2 is a diagram of the preferred embodiment of the device showing steps performed when instructions on a computer readable medium are executed.

FIG. 3 is a diagram of optional steps in embodiments of the invention.

### DESCRIPTION OF EMBODIMENTS

In the following description, reference is made to the accompanying drawings, which form a part hereof and which illustrate preferred embodiments of the present invention. The drawings and the preferred embodiments of the invention are presented with the understanding that the present invention is susceptible of embodiments in many different forms and, therefore, other embodiments may be utilized and structural, and operational changes may be made, without departing from the scope of the present invention. The first digit in the reference numbers referred to herein represents the figure number in order to easily determine which figure should be consulted to find the reference number.

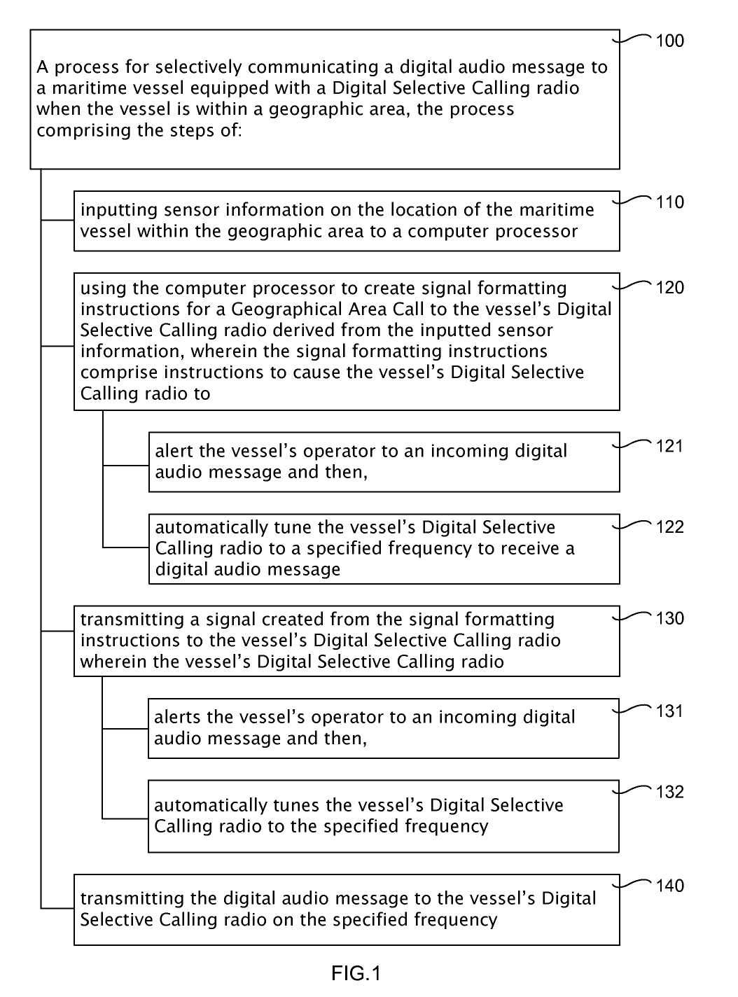

FIG. 1 illustrates the process of a preferred embodiment of the invention. Process steps may be performed in any order that results in selectively communicating a digital audio message to a maritime vessel equipped with a Digital Selective Calling radio when the vessel is within a geographic area (100). A Digital Selective Calling radio uses Geographical Area Call formatting, preferably as set forth in the International Telecommunications Union's latest standard in the series designated ITU-R M.493. Digital Selective Calling with Geographical Area Call functionality is employed to selectively communicate warnings or instructions shore-to-ship, ship-to-ship and ship-to-shore directions in order to expedite the handling of traffic in maritime mobile service.

A first step (110) in a preferred process comprises inputting sensor information on the location of the maritime vessel within the geographic area to a computer processor. Numerous sensors are available to identify the location of a maritime vessel within a geographic area. Such sensors include, but are not limited to, a motion detector, radar, an optical camera, an infrared camera, an Automatic Identification System receiver, sonar, and a terrestrial radio direction finder. Established techniques, specific to each particular sensor, may then be used to determine an approximate latitude and longitude of the vessel.

For purposes of the invention, location data inputted to the computer processor may be in any form amenable to formatting a Geographical Area Call to the vessel. A minimal sensor configuration may consist of a single, inexpensive motion sensor. In the case of short-range sensors such as motion detectors, location data used in the process is simply the detection event and the latitude and longitude where the motion detector is set to detect a vessel's presence. For very small geographic areas, this may simply be the latitude and longitude at the location where the audio file is being transmitted. In that case, the inputting step is simply loading data on the motion sensor detection event coupled with latitude and longitude information available from either its storage location or from an optionally integrated Global Positioning System receiver connected to the computer processor.

If long-range detection and positioning of non-Automatic-Identification-System vessels is required, maritime radar would be preferably employed as a sensor. Optical and infrared cameras provide visual capability over short to medium ranges. Terrestrial direction finding equipment and sub-surface acoustical sensors could also be used for vessel location information input.

A second step (120) in a preferred process comprises using the computer processor to create signal formatting instructions for a Geographical Area Call to the vessel's Digital Selective Calling radio derived from the inputted sensor information. The signal formatting instructions comprise a first instruction (121) to cause the vessel's Digital Selective Calling radio to alert the vessel's operator to an incoming digital audio message and then a second instruction (122) to automatically tune the vessel's Digital Selective Calling radio to a specified frequency to receive a digital audio message.

The creation of signal formatting by the computer processor is optionally enhanced by connecting a Global Positioning System receiver that in turn is connected to an external Global Positioning System antenna in order to automatically determine the position of the vessel relative the audio file transmission point. Location coordinates of the geographic area or simply the location coordinates of the audio file transmission point may be manually programmed into the computer processor to enhance creation of the signal formatting instructions.

This first step (110) is preferably implemented when a sensor detects a target vessel that meets certain criteria such as size, speed, course, or merely its presence within the defined geographic area. When one or more of these criteria are met, the computer processor is preferably automatically fed location or positional data on the target vessel from the sensor of from within memory storage. This data is preferably in the latitude and longitude coordinates of the vessel, but may be in a data form where latitude and longitude can be calculated, or may be in some other data form where the location of the vessel can be approximated by any other means.

The process (300) may further comprise an optional step (310) of receiving input of frequency use data from a radio receiver/scanner into the computer processor. Input of such frequency use data enables the computer processor to select from among a plurality of frequencies, a preferred specified frequency to send the digital audio message. This step (310) essentially enables selection and use of a clear radio frequency, so as to minimize the possibility that the communication might be confused with a communication of another using the same frequency. While selection of a clear frequency is preferable, the invention may also be implemented by use of a fixed frequency for communication of the digital audio message or a randomly selected available frequency.

In implementing this optional step (310), a scanner and frequency selector module would be used to choose a clear (unused) channel for transmission of the audio file or follow-on voice communications. The computer processor would preferably be connected to a standard radio antenna through a transmit/receive relay, which permits both transmitter and receiver to use the same antenna. The frequency selected for audio file transmission and any subsequent voice communications is preferably routed from a scanner and frequency selector, through computer processor for geographical area call formatting.

A third step (130) in a preferred process comprises transmitting a signal created from the signal formatting instructions to the vessel's Digital Selective Calling radio. Transmitting the signal is performed preferably by the computer automatically activating a radio transmitter and then sending the signal created from the formatting instructions. Once Digital Selective Calling is properly formatted to “ring” the radio of the subject vessel, it is outputted to the radio transmitter as a sequence of audio tones which modulate the appropriate carrier frequency in accordance with ITU-R M493 series protocol.

Upon transmitting the signal, the vessel's Digital Selective Calling radio receives the signal and alerts the vessel's operator to an incoming digital audio message (131). This is typically by an alarm signal or other audio indication of an incoming message. Upon such alert, the transmitted signal then, automatically tunes the vessel's Digital Selective Calling radio to the specified frequency (132).

A fourth step (140) in a preferred process comprises transmitting the digital audio message to the vessel's Digital Selective Calling radio on the specified frequency. The audio file would typically be a pre-recorded message that could be immediately accessed for transmission by the computer processor. Preferably, the computer processor would automatically send the audio file by activating a radio transmitter.

In implementing the process of the invention, a computer processor preferably receives commands from a human operator via a Graphical User Interface. The computer operator would typically utilize a basic radio control software program running on the computer processor to control external radio transmitter parameters such as output power, audio levels, modulation type, mark/space frequency, and baud rate. The operator would also preferably control the size of the Digital Selective Calling Geographical Area Call “box” by selecting the length, in degrees, of the vertical and horizontal sides as explained infra in example 1. Although the resolution of a standard Digital Selective Calling Geographical Area Call is limited to one-degree increments, or roughly 60 nautical miles, calls formatted in accordance with a Digital Selective Calling expansion sequence set forth in ITU M.821 allows for improved resolution to one minute increments, or about a mile per side.

### EXAMPLE 1

Digital Selective Calling is a synchronous system using characters composed from a ten-bit error-detecting code. The first seven bits of the ten-bit code are information bits. Bits 8, 9 and 10 indicate, in the form of a binary number, the number of B elements that occur in the seven information bits, a Y element being a binary number 1 and a B element a binary number 0. The order of transmission for the information bits is least significant bit first but for the check bits it is most significant bit first. Time diversity is provided in the call sequence as follows: Apart from the phasing characters, each character is transmitted twice in a time-spread mode; the first transmission of a specific character is followed by the transmission of four other characters before the re-transmission of that specific character takes place, allowing for a time-diversity reception interval of 33⅓ ms for VHF radio-telephone channels.

The classes of emission, frequency shifts and modulation rates are as follows: Frequency modulation with a pre-emphasis of 6 dB/octave (phase modulation) with frequency-shift of the modulating sub-carrier for use on VHF channels. Frequency-shift between 1300 and 2100 Hz; the sub-carrier being at 1700 Hz; the frequency tolerance of the 1300 and 2100 Hz tones is ±10 Hz; the modulation rate is 1200 Baud; the index of modulation is 2.0±10%. Each segment the format and sequence of a Digital Selective Calling transmission is described in detail in the ITU-R M.493 series of publications. For purposes of this example, only the Call Content segment applies to the process of the invention.

Digital Selective Calling Geographical Area Call. For a selective call directed to a group of ships in a particular geographic area, a numerical geographic coordinates address consisting of ten digits (i.e. 5 characters), is constructed. In order to comply with commonly accepted practice, the order of entry and read-out should be: first latitude and then longitude. The following characteristics describe the Geographical Area Call:
The designated geographic area will be a rectangle in Mercator projection;
The upper left-hand (i.e. North-West) corner of the rectangle is the reference point for the area.
The first digit indicates the azimuth sector in which the reference point is located, as follows: quadrant NE is indicated by the digit “0”, quadrant NW is indicated by The digit “1”, quadrant SE is indicated by the digit “2”, quadrant SW is indicated by the digit “3”;
The second and third digits indicate the latitude of the reference point in tens and units of degrees;
The fourth, fifth and sixth digits indicate the longitude of the reference point in hundreds, tens and units of degrees;
The seventh and eighth digits indicate the vertical (i.e. North-to-South) side of the rectangle in tens and units of degrees; and,
The ninth and tenth digits indicate the horizontal (i.e. West-to-East) side of the rectangle in tens and units of degrees.

For example, consider a call box representing a geographical area where a message would be sent, has as its upper left corner as its reference point in the North-West quadrant. Therefore, the first digit of the reference point address would be designated “1.” The second and third digits of the address indicate the latitude of the reference point, e.g. “10.” Digits 4-6 correspond to the longitude of the reference point, e.g. “020.” Digits 7-8 indicate the length of the vertical side of the box, e.g. 10 degrees North to 10 degrees South, or “20.” Finally, digits 9-10 indicate the length of the horizontal side of the box, e.g. 20 degrees West to 10 degrees East, or “30.” The ten-digit address for this particular Geographical Area Call is “1100202030.” Generally, the preferred embodiment of the process of the invention maximizes call selectivity by defining the call box as narrowly as possible, thereby establishing communications with the subject vessel while remaining transparent to all other actors in the maritime community.

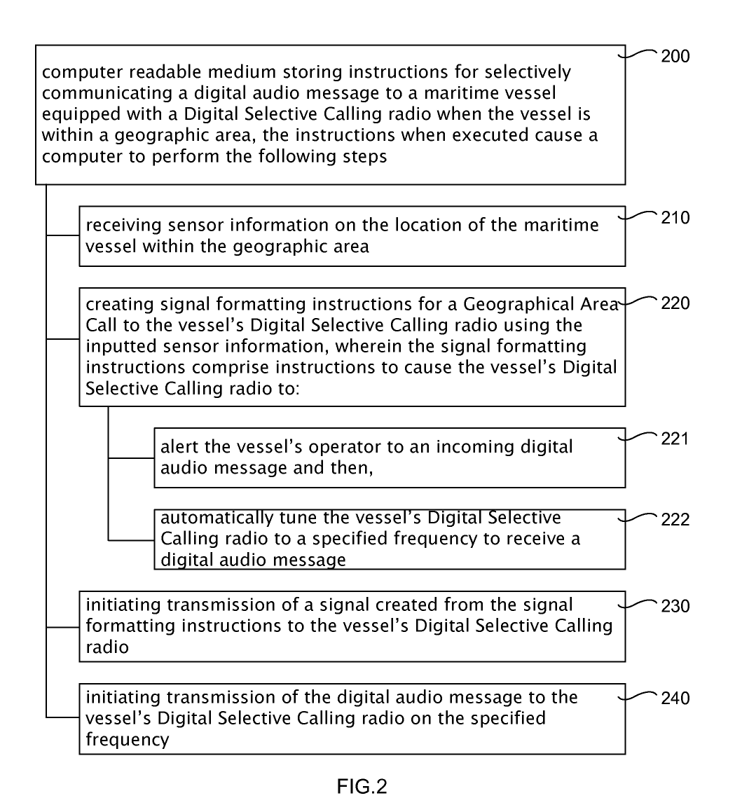

FIG. 2 illustrates an alternative embodiment of the invention in the form of an apparatus or device to enable the method of the invention to be implemented. The apparatus encompasses a computer readable medium storing instructions for selectively communicating a digital audio message to a maritime vessel equipped with a Digital Selective Calling radio when the vessel is within a geographic area, the instructions when executed cause a computer to perform the certain steps (200), discussed below, in any order that will result in communication of the digital audio message.

A first step (210) performed by the computer is receiving sensor information on the location of the maritime vessel within the geographic area. The scope of this step is consistent with that described above for the first step (110) of the process of the invention.

A second step (220) performed by the computer is creating signal formatting instructions for a Geographical Area Call to the vessel's Digital Selective Calling radio using the received sensor information from the first step (210). The signal formatting instructions comprise a first instruction (221) to cause the vessel's Digital Selective Calling radio to alert the vessel's operator to an incoming digital audio message. The signal formatting instructions further comprise a second instruction (222) to automatically tune the vessel's Digital Selective Calling radio to a specified frequency to receive a digital audio message. Means and methods to create these instructions are well known in the art.

A third step (230) performed by the computer is initiating transmission of a signal created from the signal formatting instructions to the vessel's Digital Selective Calling radio. A means for performing this act is consistent with that described above for the third step (130) of the process of the invention.

A fourth step (240) performed by the computer is initiating transmission of the digital audio message to the vessel's Digital Selective Calling radio on the specified frequency. A means for performing this act is consistent with that described above for the fourth step (140) of the process of the invention.

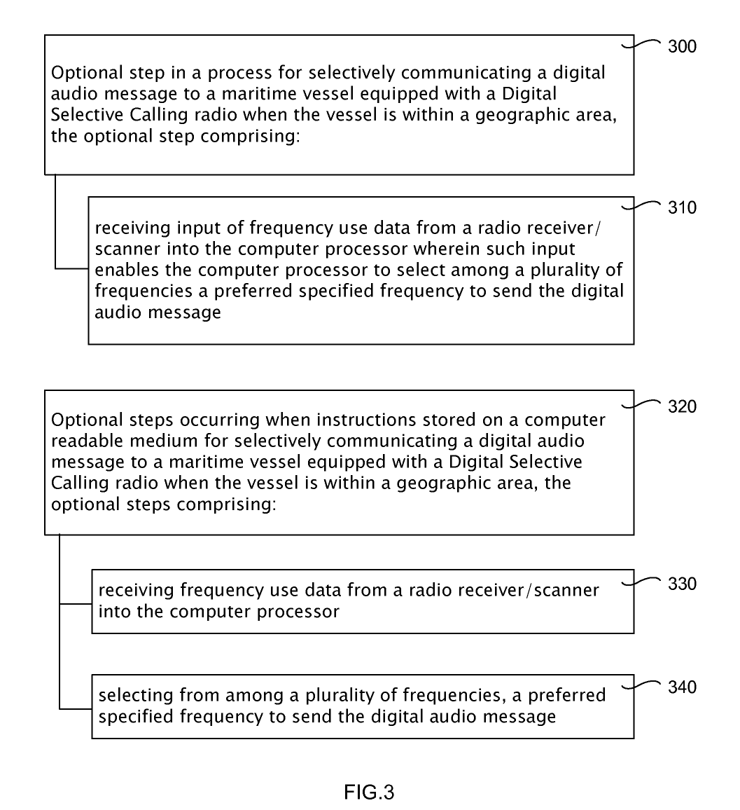

FIG. 3 describes optional additional steps performed by computer when the instructions stored on the computer readable medium are executed (320). The first such optional step (330) is receiving frequency use data from a radio receiver/scanner into the computer processor. A means for performing this act is consistent with that described above for the optional step (310) of the process of the invention.

The second such optional step (340) is selecting from among a plurality of frequencies, a preferred specified frequency to send the digital audio message. A means to detect a clear or preferred specified frequency for radio transmission is well known in the art.

### EXAMPLE 2

The computer readable medium is used to store a digital voice (audio) message file which is used to communicate specific instructions or warnings to the target vessel after initial radio contact has been established through the Digital Selective Calling Geographical Area Call. The digital audio message would typically be created by an operator either by typing a message using a graphical user interface to the computer processor, or by speaking into a microphone and using software for creation of a digital audio message. In either case, the audio message is preferably digitized and stored on the computer readable medium as a standard “.wav” or other audio file. Once the recipient vessel's Digital Selective Calling radio has automatically tuned to the frequency specified in the initial Digital Selective Calling transmission, the computer processor accesses the stored audio file and outputs it to an external transmitter for broadcast on the specified frequency. An operator can manually select the digital audio file or have the computer processor select it automatically, depending on the specific mission or application. For instance, a computer processor operator may choose to transmit a digital voice message in various languages and dialects in order to effectively communicate with the target vessel's master.

The above-described embodiments including the drawings are examples of the invention and merely provide illustrations of the invention. Other embodiments will be obvious to those skilled in the art. Thus, the scope of the invention is determined by the appended claims and their legal equivalents rather than by the examples given.

### INDUSTRIAL APPLICABILITY

The invention has application in maritime safety, port security, military force protection, and Maritime Domain Awareness industries.

What is claimed is:

1. A process for selectively communicating a digital audio message to a maritime vessel equipped with a Digital Selective Calling radio when the vessel is within a geographic area, the process comprising the steps of:
inputting sensor information on the location of the maritime vessel within the geographic area to a computer processor;
using the computer processor to create signal formatting instructions for a Geographical Area Call to the vessel's Digital Selective Calling radio derived from the inputted sensor information, wherein the signal formatting instructions comprise instructions to cause the vessel's Digital Selective Calling radio to
alert the vessel's operator to an incoming digital audio message and then,
automatically tune the vessel's Digital Selective Calling radio to a specified frequency to receive a digital audio message;
transmitting a signal created from the signal formatting instructions to the vessel's Digital Selective Calling radio wherein the vessel's Digital Selective Calling radio
alerts the vessel's operator to an incoming digital audio message and then,
automatically tunes the vessel's Digital Selective Calling radio to the specified frequency; and,
transmitting the digital audio message to the vessel's Digital Selective Calling radio on the specified frequency.

2. The process of claim 1 further comprising the step of receiving input of frequency use data from a radio receiver/scanner into the computer processor wherein such input enables the computer processor to select among a plurality of frequencies a preferred specified frequency to send the digital audio message.

3. A computer readable medium storing instructions for selectively communicating a digital audio message to a maritime vessel equipped with a Digital Selective Calling radio when the vessel is within a geographic area, the instructions when executed cause a computer to perform the following steps:
receiving sensor information on the location of the maritime vessel within the geographic area;
creating signal formatting instructions for a Geographical Area Call to the vessel's Digital Selective Calling radio using the inputted sensor information, wherein the signal formatting instructions comprise instructions to cause the vessel's Digital Selective Calling radio to:
alert the vessel's operator to an incoming digital audio message and then,
automatically tune the vessel's Digital Selective Calling radio to a specified frequency to receive a digital audio message; and,
initiating transmission of a signal created from the signal formatting instructions to the vessel's Digital Selective Calling radio, and,
initiating transmission of the digital audio message to the vessel's Digital Selective Calling radio on the specified frequency.

4. The computer readable medium of claim 3 wherein the instructions when executed cause a computer to perform additional steps comprising:
receiving frequency use data from a radio receiver/scanner into the computer processor; and,
selecting from among a plurality of frequencies, a preferred specified frequency to send the digital audio message.
